(19) United States
(12) Patent Application Publication
(10) Pub. No.: US 2010/0145871 A1
(43) Pub. Date: Jun. 10, 2010

(54) PAPERLESS SYSTEM AND METHOD FOR DELIVERING MAIL

(76) Inventors: Moshe Kesem, Fort Lauderdale, FL (US); Moshe Hen, Fort Lauderdale, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/356,618

(22) Filed: Jan. 21, 2009

Related U.S. Application Data
(60) Provisional application No. 61/121,208, filed on Dec. 10, 2008.

(51) Int. Cl. G06Q 50/00

(52) U.S. Cl. 705/332

(57) ABSTRACT

A system and method for receiving, sorting, distributing, transporting, and delivering electronic documents via the U.S. Postal Service's fleet of surface mail delivery vehicles, or the vehicles of any other suitable entity having a surface delivery fleet, is disclosed. Electronic “mail” generated by senders is electronically received and sorted by the Postal Service. Each received piece of mail includes a street address tag that identifies the physical street address (or P.O. Box) to which the communication is to be delivered. The received communications are sorted and all communications intended for delivery on a certain route are stored on a data storage device, such as a USB flash drive, for delivery via a surface fleet vehicle to the intended recipient's mailbox. Mailboxes are adapted with an electronic data storage module capable of receiving and storing digital documents from the delivery person's data storage device. The postal delivery person plugs the flash drive into a data transfer port associated with the mailbox. Once plugged in, the data automatically synchronizes such that all data intended for that recipient is transferred from the flash drive to a data storage device physically incorporated in the otherwise conventional mailbox. The recipient may retrieve the “mail” by plugging in his/her flash drive whereby the data is electronically transferred to the recipient's flash drive whereafter it may be retrieved and viewed using a display, such as found on a home computer. The invention thus reduces and/or eliminates paper mail and saves labor and fuel.

### CROSS REFERENCE TO RELATED APPLICATIONS

This application claims the benefit of provisional U.S. Patent Application Ser. No. 61/121,208, filed on Dec. 10, 2008.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all rights whatsoever.

### BACKGROUND OF THE INVENTION

1. Field of the Invention

The present invention relates to the transmission and delivery of information, and more particularly to a paperless system and method for delivering mail that utilizes a surface delivery entity, such as the U.S. Postal Service or other delivery corporation, to receive and sort electronic communications and deliver the communications to recipients via surface delivery and electronic transfer.

2. Description of Related Art

Mankind has long had a compelling desire to communicate. If remote communication was required then messages had to be physically carried or sent by messenger. The history of formal mail service in the United States dates back to 1639, when the state court of Massachusetts established the first government-authorized drop-off point for mail, namely a tavern in Boston. In those days, it was quite common for local stores and taverns to be used as mail drop points whereby citizens became accustomed to inquiring for their mail.

The first postal service in America arose in 1692, when the English government empowered Thomas Neale to “erect, settle and establish within the chief parts of their majesties' colonies and plantations of America, an office or offices for the receiving and dispatching of letters and pacquets, and to receive, send and deliver the same under such rates and sums of money as the planters shall agree to give.” The English government renounced their agreement just 16 years later, and in 1707 they appointed a local deputy to the status of “postmaster general.” By 1774, the colonists had reached their limit with the English crown's dictation. Frustration over the postal service was one of the lesser known issues that prompted the colonists to seek their own independent government.

In 1775, the Continental Congress created a Post Office Department and appointed Benjamin Franklin as the first Postmaster General of that organization. The Postal Act of 1792 clearly outlined the mission of the newly formed Post Office Department. A rate structure was established to allow newspapers to be mailed at a very low rate so as to promote independent news organization and to help keep the citizenry well informed. There were also provisions to prevent opening and reading of any private mail. This was very important to the colonists who had a strong distaste for government intervention as practiced by the English. Mail could only be opened if it had been deemed “undeliverable.”

In 1970, the Postal Reorganization Act established the USPS as a government agency that could be operated with tax support as a semi-independent federal monopoly. The postal service was also mandated to be revenue neutral, or in other words, to be a not-for-profit organization.

Today, the U.S. Postal Service delivers to more than 141 million businesses and homes each day. It is the only U.S. government sanctioned monopoly, and it operates very efficiently in spite of having no competition. From its humble origins in a Boston tavern in the 17th century, The United States Postal Service has gone on to become the organization we all know and rely upon every day to deliver mail.

The current postal system and other surface delivery entities are burdened with significant inherent disadvantages and inefficiencies that result in high costs realized in connection with the delivery of mail and parcels. First, the handling and sorting of conventional mail and parcels is an extremely time consuming and laborious procedure. In addition, transportation of large amounts of conventional mail and parcels over surface streets consumes excessive amounts of energy. Further, there are substantial costs and energy consumed with the physical handling, storage, and transport of mail and parcels.

Another form of communication and information delivery involves the transmission of messages electronically. In 1837 an electrical telegraph was developed and patented by Samuel F. B. Morse. The telegraph used the now famous Morse code signaling alphabet to generate the message. The first commercially successful transatlantic telegraph cable was completed in 1866. Further advancements in telegraph technology occurred in the early 1870's when Thomas Edison devised a full duplex two way telegraph and then doubled its capacity with the invention of the quadruplex telegraphy in 1874. Edison filed for and obtained U.S. Pat. No. 480,567 for his Duplex Telegraph in 1892. By 1935, large telegraphy providers began to develop systems that used telephone-like rotary dialing to connect teletypes. These machines were called “Telex” machines. In 1958, Western Union Telegraph Company began development of a telex network in the United States.

Around 1965, the Defense Advanced Research Projects Agency (DARPA) commissioned a study of decentralized switching systems. Technological developments resulting from that study provided inspiration for the development of the ARPANET packet switching research network, which later grew to become the public Internet. By the early 1990s, modems made e-mail a viable alternative to telex systems. The broad user base created by the demand for e-mail smoothed the way for the rapid acceptance of the World Wide Web in the mid 1990s.

It is widely recognized that e-mail will never replace conventional mail. First, while North America leads the world in Internet penetration, a large number of people simply do not use the Internet. In addition, a percentage of those that access the Internet do not use e-mail. Finally, the lack of a comprehensive directory of e-mail addresses renders targeted communications impossible. Further the Internet is largely unregulated, and virtually impossible to regulate, and thus not a secure means of communication.

As a result of the aforementioned limitations and disadvantages recognized in the background art, a number of attempts have been made improve upon the delivery of mail. For example, U.S. Patent Publication No. 200310074411 to Nale, discloses a system for receiving and processing mail items by scanning the mail and transmitting image files to subscribers via e-mail. U.S. Pat. No. 6,732,152, issued to Lockhart et al., discloses a system for transmitting mail files to a mail service computer via the Internet, printing the mail files, and placing the printed mail files into a surface mail system (e.g. U.S. Postal Service) where mail items are delivered to the postal address of the intended recipients. U.S. Pat. No. 6,856,860, issued to Stringham et al., discloses a method of distributing mail wherein information is electronically transmitted to postal delivery vehicles for printing. Finally, U.S. Pat. No. 7,299,422, issued to Levine et al., discloses a system and method for transferring information from a first computer to a portable storage device (such as a USB storage token), and from the portable storage device (via USB port) to a second computer.

The above-referenced disclosures fail to adequately address the limitations and disadvantages present in the art. Accordingly, there exists a need for an improved system and method for delivering mail via surface streets.

### BRIEF SUMMARY OF THE INVENTION

The present invention overcomes the limitations and disadvantages present in the art by providing a system and method for receiving, sorting, distributing, transporting, and delivering electronic documents via a fleet of surface mail delivery vehicles, preferably the U.S. Postal Service fleet. While the present invention will be described in connection with the U.S. Postal Service, it is adaptable for use with any postal or delivery agency having a fleet of surface delivery vehicles. In accordance with the present invention, “mail” is electronically received and sorted by the Postal Service. Each received communication will include a street address identification or tag that identifies the physical street address (or P.O. Box) to which the communication is to be delivered. The received communications are sorted whereby all communications intended for delivery on a certain route are stored on any suitable data storage device, such as a USB flash drive, for delivery via a surface fleet vehicle to the intended recipient's mailbox. In accordance with the present invention, an otherwise conventional mailbox is adapted with an electronic data storage module capable of receiving and storing digital documents from the delivery person's data storage device. The postal delivery person physically drives a vehicle to each recipient's house/mailbox. Rather than placing paper mail in the mailbox, however, the postal delivery person simply electronically transfers the dates, e.g. by plugging in a flash drive into a data transfer port associated with the mailbox. In an alternate embodiment, the electronic transfer may be wireless, such as by Bluetooth enabled transmission and receiving hardware. Bluetooth is a wireless protocol for exchanging data over short distances from fixed and mobile devices. The electronic transfer results in automatic data synchronization such that all data intended for that recipient is transferred from the flash drive to a data storage device physically incorporated in the otherwise conventional mailbox. The recipient may retrieve the “mail” by plugging in his/her flash drive whereby the data is electronically transferred to the recipient's flash drive whereafter it may be retrieved and viewed using a display, such as found on a home computer. Furthermore, the “mail” may be viewed on the recipient's telephone, television, personal digital assistant (“PDA”), portable media player, or any other suitable electronic device. In addition, the data may be retrieved via wireless transmission, e.g. Bluetooth, or by any other suitable data transfer means. The invention thus reduces and/or eliminates paper mail and saves labor and fuel, and provides a significant environmentally friendly (i.e. “Green”) alternative to conventional mail delivery.

Accordingly, it is an object of the present invention to provide an improved system and method for the delivery of mail.

Another object of the present invention is to provide such a system wherein documents are electronically received, sorted, and digitally stored on portable data storage devices by the postal service or other delivery company.

Still another object of the present invention is to provide such a system wherein portable data storage devices are transported to recipients via surface fleet vehicles.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a flow chart illustrating a system and method that utilizes the U.S. Postal Service to receive and sort electronic communications and deliver the communications to recipients via surface transfer in accordance with the present invention.

### DETAILED DESCRIPTION OF THE INVENTION

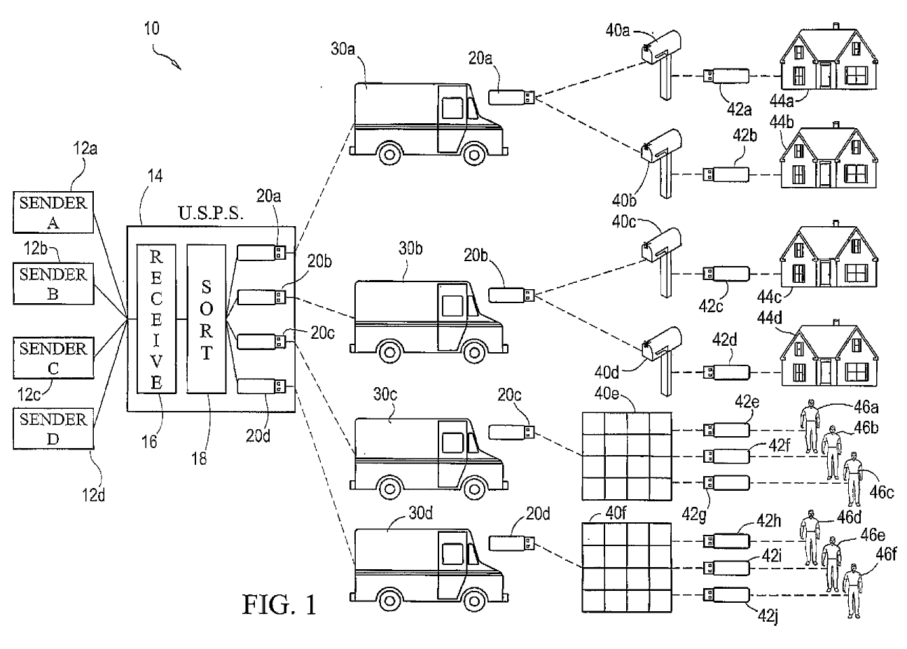

With reference now to the drawing, FIG. 1 illustrates a system and method, generally referenced as 10, that utilizes the U.S. Postal Service (“USPS”) to receive and sort electronic communications and deliver the communications to recipients via surface transfer in accordance with the present invention. Mail delivery system and method 10 overcomes the limitations and disadvantages present in the art by providing a system and method for receiving, sorting, distributing, transporting, and delivering electronic documents via the U.S. Postal Service's fleet of surface mail delivery vehicles. While the present invention will be described in connection with the USPS, it is adaptable for use with any postal or delivery company having a fleet of vehicles.

In accordance with the present invention, “mail” is generated by a plurality of senders, referenced as 12a-12d, and electronically transmitted to the USPS (or other delivery entity), generally referenced as 14, for ultimate delivery to recipients. The electronically transmitted “mail” preferably includes electronic files, such as documents, sound or music files, photographs or images, or any other digital information. In addition, each piece of mail will include street address identification information or street I.D. tag that identifies the physical street address (or P.O. Box) to which the communication is to be delivered. The mail is received 16 by the USPS 14, or any other suitable alternate delivery entity. Next, the received mail communications are electronically sorted 18 wherein the street address tags identify all communications intended for delivery on a certain surface delivery route. Those electronic mail communications are stored on a data storage device 20, such as a USB flash drive or any other suitable data storage system, for delivery via a surface fleet vehicle to the intended recipient's mailbox. Accordingly, each local postal facility stores mail in electronic form (e.g. digital data) on a plurality of data storage devices, referenced as 20a-20d.

The various storage devices are physically transferred to surface delivery vehicles, referenced as 30a-30d. In the embodiment wherein the delivering entity is the USPS, delivery vehicles 30 comprises postal delivery vehicles manned by a postal employee (e.g. a mailman). Delivery vehicles 30 physically transport data storage devices 20 across surface streets to various addresses, identified as mail boxes referenced as 40a-40e, along the route. In accordance with the present invention, the otherwise conventional mail boxes 40a-40e are each adapted with an electronic data storage module capable of receiving and storing digital documents from the delivery person's data storage device 20a-20d. Accordingly, as each postal delivery vehicle 30 reaches an intended recipient's mailbox 40 the delivery person simply plugs the portable data storage device into a data transfer port associated with the mailbox. Once plugged in, the data automatically synchronizes such that all data intended for that recipient, based on the address tag data, is transferred from the portable data storage device 20 to the data storage module physically incorporated in the otherwise conventional mailbox 40. In an alternate embodiment, the electronic transfer may be wireless, such as by Bluetooth enabled transmission and receiving hardware. Bluetooth is a wireless protocol for exchanging data over short distances from fixed and mobile devices. Accordingly, the present invention contemplates any suitable form of wired or wireless data transfer. Wireless transmission may be by radio wave or light beam (e.g. infrared).

As best illustrated in FIG. 1, the mailboxes may be conventional curbside mailboxes referenced as 40a-40d. In this embodiment, the recipient is able to physically retrieve the electronic mail by simply walking out to his/her mailbox and inserting a portable storage device, referenced as 42, into the data storage module associated with the mailbox whereby the a synchronization process downloads the mail from the data storage module to the recipient's data storage device 42. Once the data is downloaded to the recipient's data storage device 42, the mail may be reviewed by the recipient in the comfort of his/her home 44 using a suitable electronic device, including without limitation a computer, flash reader, portable digital assistant (PDA), wireless telephone-enabled device, or other specially adapted electronic device. In addition, the present invention contemplates use with a group mailboxes referenced as 40c-40f, of the type found in apartment complexes and condominiums. In this configuration, the portable data storage device (20c or 20d) may be inserted one-time into a group mailbox, referenced as 40e and 40f, whereby the synchronization step includes sorting and routing the mail to each appropriate individual mailbox based on the street address tag associated with each piece of mail. To retrieve the mail, the individual recipients, referenced as 46a-46f, simply insert their portable data storage devices, referenced as 42e-42j, into their respective mail box 40e or 40f whereby the synchronization step includes sorting and routing the mail to each appropriate individual mailbox based on the street address tag associated with each piece of mail. The present invention thus results in significant time savings by largely eliminating manual sorting, transportation, and delivery of mail.

The instant invention has been shown and described herein in what is considered to be the most practical and preferred embodiment. It is recognized, however, that departures may be made to therefrom within the scope of the invention and that obvious modifications will occur to a person skilled in the art.

What is claimed is:

1. A method of delivering paperless electronic mail to recipients using a fleet of surface delivery vehicles each vehicle servicing a plurality of street addresses along a route, said method comprising:
receiving a plurality of electronic communications from a plurality of senders, each of said electronic communications including a street address identifying an intended recipient;
sorting received electronic communications by street address;
digitally storing sorted electronic communications to a plurality of portable data storage devices;
transferring said portable data storage devices to a fleet of surface delivery vehicles, each of said delivery vehicles servicing a plurality of street addresses along an assigned route;
said fleet of surface delivery vehicles transporting said data storage devices to street addresses along the vehicles assigned route; and
delivering said electronic communications to intended recipients by electronic transfer to mailboxes configured to electronically receive and store digital data.

2. A method of delivering paperless electronic mail according to claim 1, further including the step of electronically transferring stored digital data from said mailboxes.

3. A method of delivering paperless electronic mail according to claim 1, wherein said electronic communications include electronic files including documents, audio files, music files, photographs, and images.
